(19) United States
(12) Patent Application Publication
(10) Pub. No.: US 2006/0208702 A1
(43) Pub. Date: Sep. 21, 2006

(54) Method & apparatus to provide charging waveform to lithium ion batteries

(76) Inventor: John Fee, Garland, TX (US)

Correspondence Address: JACKSON WALKER LLP, 901 MAIN STREET, SUITE 6000, DALLAS, TX, 75202-3797, US

(21) Appl. No.: 11/363,572

(22) Filed: Feb. 27, 2006

Related U.S. Application Data
(60) Provisional application No. 60/656,284, filed on Feb. 25, 2005.
(60) Provisional application No. 60/657,091, filed on Feb. 25, 2005.
(60) Provisional application No. 60/656,285, filed on Feb. 25, 2005.
(60) Provisional application No. 60/656,283, filed on Feb. 25, 2005.

(51) Int. Cl. H02J 7/00

(52) U.S. Cl. 320/131

(57) ABSTRACT

The present invention achieves technical advantages by providing a charging waveform which helps minimize the aforementioned affects. The waveform may consist of a modified Sine Wave charging cycle, followed by a rest period, followed by a Burp Period, followed by a rest period. This waveform is primarily intended to reduce the Lithium's sensitivities to sharp rise time currents which directly relate to heat and the battery ability to accept charge current and remain stable.

### CLAIM OF PRIORITY

This application claims priority of U.S. Provisional application Ser. No. 60/656,284 filed Feb. 25, 2005, entitled “Method & Apparatus to Provide Adaptive Variable Frequency Charging Pulses to Nickel and SLA Battery Types”; U.S. Provisional application Ser. No. 60/657,091 filed Feb. 25, 2005, entitled “Method & Apparatus to Ensure That Saturation Of the Battery Does Not Occur During Resonant Finding Phase As Well As Implementation Methods To Quickly Find Resonance”; U.S. Provisional application Ser. No. 60/656,285 filed Feb. 25, 2005 entitled “Method and Apparatus to Provide Charging Waveform To Lithium Ion Batteries”; and U.S. Provisional application Ser. No. 60/656,283, filed Feb. 25, 2005, entitled “Method and Apparatus to Provide Programmable Waveform Generator Battery Charger”.

Problem: Today's market demands more portability and in particular battery technology with more energy density. Lithium Ion is one of these batteries which can meet these demands; however Lithium batteries are unstable by nature. In particular they are sensitive to charge current and over temperature.

### BRIEF DESCRIPTION OF DRAWINGS

FIG. 1 is a waveform of a modified Sine Wave charging cycle.

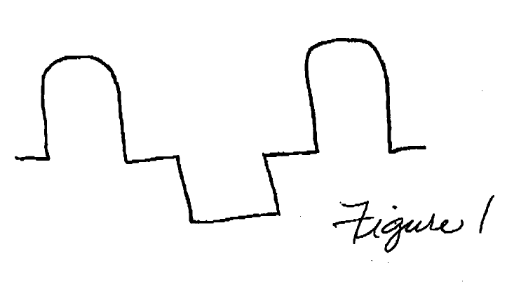

Solution: The present invention achieves technical advantages by providing a charging waveform which helps minimize the aforementioned affects. The waveform may consist of a modified Sine Wave charging cycle, followed by a rest period, followed by a Burp Period, followed by a rest period. This waveform is primarily intended to reduce the Lithium's sensitivities to sharp rise time currents which directly relate to heat and the battery ability to accept charge current and remain stable. The waveform looks like the following in FIG. 1.

We claim:

1. A battery charger adapted to charge a battery while reducing battery sensitivity to sharp rise time currents.
